(19) United States
(12) Patent Application Publication
(10) Pub. No.: US 2005/0144456 A1
(43) Pub. Date: Jun. 30, 2005

(54) Robust digital image watermarking utilizing a Walsh transform algorithm

(76) Inventors: Tinku Acharya, Chandler, AZ (US); Bhargab B. Bhattacharya, Calcutta (IN); Malay K. Kundu, Calcutta (IN); C. A. Murthy, Calcutta (IN); Santi P. Maity, Calcutta (IN)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/734,691

(22) Filed: Dec. 11, 2003

(51) Int. Cl. H04L 9/00

(52) U.S. Cl. 713/176

(57) ABSTRACT

Disclosed is a method, apparatus, and system to provide for robust digital image watermarking utilizing a Walsh transform algorithm. A first image processor performs operations including partitioning a cover image, generating a key, and inserting a watermark symbol into the cover image utilizing a Walsh transform and the key. A second image processor performs operations including extracting the watermark symbol from the cover image utilizing a Walsh transform and the key.

### FIELD

Embodiments of the invention relate generally to digital image processing, and more particularly, to robust digital image watermarking techniques utilizing a Walsh transform algorithm.

### DESCRIPTION OF RELATED ART

Rapid and extensive growth in Internet technology has created a pressing need to develop techniques to protect copyright ownership and the content integrity of digital media content. This demand has arisen because digital representation of medias, with their inherent advantages of portability, efficiency, accuracy of information, and ease of copying, places digital media content under a serious threat because an unlimited number of perfect copies of an unprotected digital content can be illegally made with relative ease. One proposed solution to this problem is the use of a electronic stamp or digital watermarking, which is intended to complement a cryptographic process. See, for example, R. Anderson, Information Hiding, Proceedings of the First Workshop on Information Hiding, LNCS-1174, Springer Verlag, New York, 1996 and N. F. Jhonson and S. Jajodia, Exploring Steganography: Seeing the Unseen, Computer, vol. 31, pp. 26-34, 1998.

Basically, a digital watermark is a pattern of bits that is embedded into a file that is used to identify the source of the file. For example, if a digital watermark is placed into a master copy of an audio compact disk (CD), then all copies of that CD may be uniquely identified. Particularly, digital watermarks can also be effectively utilized in digital image files. Thus, if a digital watermark is placed into a master copy of a digital image file, then all copies of that digital image file may be uniquely identified.

Generally, all watermarking methods share the same basic building blocks: an embedding system and a watermark recovery system. See, for example, S. Katzenbesser and F. A. P Petitcolas, Information Hiding Techniques for Steganography and Digital Watermarking, Artech House, Boston, Mass., 2000. Most generic embedding systems have as inputs: a cover that is the data or image to be hidden (I), a watermark symbol (W) that can be an image, text, number, etc., and a key (K) to enforce security. Typically, most systems employ one key or a combination of several keys. Depending on the type of key used in the watermarking process (e.g. a private or public key), the watermarking process is usually referred to as a private or public watermarking process, respectively. The output of the embedding process is always the watermarked data.

Typically, a generic watermark recovery process requires the watermarked data, the private or public key, and depending on the method, the original data and/or the original watermark symbol as inputs while the output is the recovered watermark symbol with some kind of confidence measure for the given watermark symbol or an indication about the presence of watermark symbol in the cover data or image under inspection.

Depending on the combination of inputs and outputs there are generally three types of standard watermarking processes: private, semi-private, and public. See, for example, Kutter, M., F. A. P. Petitcolas, Fair Benchmarking for Image Watermarking Systems, Proceedings of the SPIE 3657, Security and Watermarking of Multimedia Contents, 1999, pp. 226-239.

For example, private watermarking systems (also called non-blind watermarking systems) typically require at least the cover image and/or watermark symbol and the key (if used in embedding) for the recovery of the watermark symbol. Two types of private systems are typically used. The first type of system (Type I) uses the cover image (I) to locate the hidden information and also to extract the watermark symbol from the possibly distorted watermarked data denoted (I″). In addition to the cover image, the second type of system (Type II) also uses a copy of the embedded watermark symbol for extraction and yields a “yes” or “no” answer about the presence of the watermark in the possibly distorted watermarked data. Mathematically this may be expressed as: (I″×I×k×W→{0, 1}).

On the other hand, public watermarking systems (also called blind or oblivious watermarking systems) require neither the cover image nor the embedded watermark symbol, but only the secret key during the detection of the hidden information (i.e. the watermark symbol). Mathematically this may be expressed as: {I″×k→W}.

Semi-private watermarking systems (also called semi-blind watermarking), as a subclass of a blind system, are capable of detecting only the presence of the embedded watermark symbol with the help of secret key and the original watermark symbol but without the cover image. Mathematically this may be expressed as: (I″×k×w→{0, 1}).

### BRIEF DESCRIPTION OF THE DRAWINGS

FIG. 1 is a flow diagram illustrating a broad overview of a process to implement robust digital image watermarking utilizing a Walsh transform algorithm, according to one embodiment of the present invention.

FIG. 2 is a flow diagram illustrating a process to implement partitioning, according to one embodiment of the present invention.

FIG. 3 is a schematic diagram illustrating an example of a shift register circuit.

FIG. 4 is a flow diagram illustrating a detailed process to implement robust digital image watermarking utilizing a Walsh transform algorithm, according to one embodiment of the present invention.

FIG. 5 shows a block diagram illustrating the extraction of a watermark symbol from the watermarked cover image, according to one embodiment of the invention.

FIGS. 6A and 6B are images showing a fishing boat and a women (named Lena), respectively, which are used as test cover images.

FIGS. 6C, 6D, 6E, 6F, and 6G show test cover images of a bear, New York, a opera, an F151 aircraft, and pills which are used in testing the robustness of the embodiments of the invention for robust digital image watermarking techniques utilizing a Walsh transform to different possible signal processing operations.

FIGS. 7A and 7B are the watermarked images of FIGS. 6A and 6B, respectively, using a watermark symbol (a hidden symbol “M”) embedded therein, using the embodiments of the invention for robust digital image watermarking techniques utilizing a Walsh transform.

FIG. 7C shows the watermark symbol “M”.

FIGS. 8A and 8B show blurred versions of a watermarked image of a fishing boat after first and second time mean filtering operations.

FIGS. 8C and 8D each show an extracted watermark symbol, which were extracted using the embodiments of the invention for robust digital image watermarking techniques utilizing a Walsh transform from FIGS. 8A and 8B.

FIGS. 9A and 9B show blurred versions of a watermarked image (Lena) after first and second time mean filtering, respectively.

FIGS. 9C and 9D each show an extracted watermark symbol, which were extracted using the embodiments of the invention for robust digital image watermarking techniques utilizing a Walsh transform from FIGS. 9A and 9B.

FIG. 10 shows a table of test result of the robustness to mean filtering for the five test images, when utilized with embodiments of the invention for robust digital image watermarking techniques utilizing a Walsh transform.

FIGS. 11A, 11B, and 11C show watermarked images of a fishing boat after 1st, 2^{nd}, and 5th time median filtering, respectively.

FIGS. 11D, 11E, and 11F show extracted watermark symbols, which were extracted using the embodiments of the invention for robust digital image watermarking techniques utilizing a Walsh transform from FIGS. 11A, 11B, and 11C, respectively.

FIGS. 12A, 12B, and 12C show watermarked Lena images after 1st, 2^{nd}, and 5th time median filtering, respectively.

FIGS. 12D, 12E, and 12F show extracted watermark symbols, which were extracted using the embodiments of the invention for robust digital image watermarking techniques utilizing a Walsh transform from FIGS. 12A, 12B, and 12C, respectively.

FIG. 13 shows a table of test results of the robustness to median filtering for the five test images when utilized with embodiments of the invention for robust digital image watermarking techniques utilizing a Walsh transform.

FIGS. 14A, 14B, 14C, and 14D show a watermarked image of a fishing boat with various image cropping operations, respectively.

FIG. 14E shows a watermarked image of a fishing boat with a border image cropping operation.

FIGS. 14F, 14G, 14H, and 14I show extracted watermark symbols, which were extracted using the embodiments of the invention for robust digital image watermarking techniques utilizing a Walsh transform from FIGS. 14A, 14B, 14C, and 14D, respectively.

FIG. 14J shows an extracted watermark symbol, which was extracted using the embodiments of the invention for robust digital image watermarking techniques utilizing a Walsh transform from FIG. 14E.

FIGS. 15A, 15B, 15C, and 15D show a watermarked Lena image with various image cropping operations, respectively.

FIG. 15E shows a watermarked Lena image with a border image cropping operation.

FIGS. 15F, 15G, 15H, and 15I show extracted watermark symbols, which were extracted using the embodiments of the invention for robust digital image watermarking techniques utilizing a Walsh transform from FIGS. 15A, 15B, 15C, and 15D, respectively.

FIG. 15J shows an extracted watermark symbol, which was extracted using the embodiments of the invention for robust digital image watermarking techniques utilizing a Walsh transform from FIG. 15E.

FIG. 16 shows a table of test results of the robustness to different types of image cropping operation for the five test images when utilized with embodiments of the invention for robust digital image watermarking techniques utilizing a Walsh transform.

FIG. 17A shows a table of test results of the robustness to JPEG compression for the five test images when utilized with embodiments of the invention for robust digital image watermarking techniques utilizing a Walsh transform.

FIGS. 17B and 17C are the extracted watermark symbol after decompression from the JPEG compressed images of FIG. 7A with compression ratios of 31.80 and 44.56, respectively.

FIGS. 18A and 18B show a watermarked Lena image undergoing least significant bit manipulation.

FIGS. 18C and 18D show extracted watermark symbols, which were extracted using the embodiments of the invention for robust digital image watermarking techniques utilizing a Walsh transform from FIGS. 18A and 18B, respectively.

FIG. 19 shows a table of test results of the robustness to deliberate least significant bit manipulation for the five test images when utilized with embodiments of the invention for robust digital image watermarking techniques utilizing a Walsh transform.

FIG. 20 shows a watermarked image of a fishing boat that has undergone changing gray scale levels.

FIG. 21 shows an extracted watermark symbol, which was extracted using the embodiments of the invention for robust digital image watermarking techniques utilizing a Walsh transform from FIG. 20.

FIG. 22A shows a watermarked Lena image that has undergone changing gray scale levels.

FIG. 22B shows an extracted watermark symbol, which was extracted using the embodiments of the invention for robust digital image watermarking techniques utilizing a Walsh transform from FIG. 22A.

FIG. 23 shows a table of test results of the robustness to different possible changes in gray scale level for the five test images when utilized with embodiments of the invention for robust digital image watermarking techniques utilizing a Walsh transform.

### DETAILED DESCRIPTION

In the following description, the various embodiments of the invention will be described in detail. However, such details are included to facilitate understanding of the invention and to describe exemplary embodiments for employing the invention. Such details should not be used to limit the invention to the particular embodiments described because other variations and embodiments are possible while staying within the scope of the invention. Furthermore, although numerous details are set forth in order to provide a thorough understanding of the embodiments of the invention, it will be apparent to one skilled in the art that these specific details are not required in order to practice the embodiments of the invention. In other instances details such as, well-known methods, types of data, protocols, procedures, components, electrical structures and circuits, are not described in detail, or are shown in block diagram form, in order not to obscure the invention. Furthermore, embodiments of the invention will be described in particular embodiments but may be implemented in hardware, software, firmware, middleware, or a combination thereof.

Embodiments of the present invention relate to a computationally efficient private watermarking technique using a Walsh transform. This watermarking process is robust against several types of external attacks and provides reduced visual distortion. In one embodiment, a block-based Walsh transform algorithm may be used to hide a watermark symbol in a cover image. For example, the watermark symbol, in one embodiment, may be copyright mark or another type of logo.

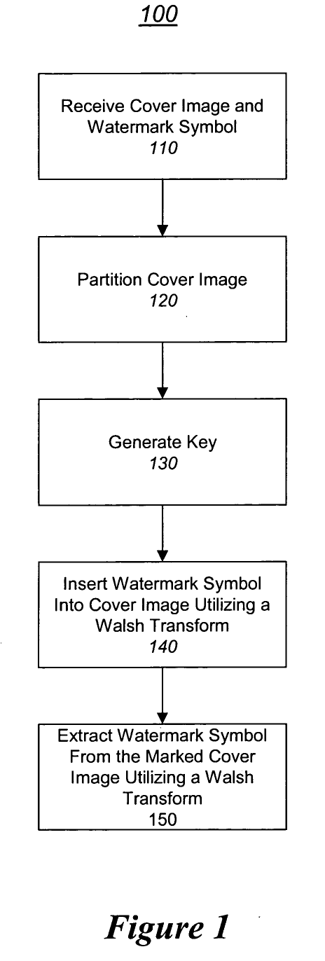

Turning to FIG. 1, FIG. 1 is a flow diagram illustrating a broad overview of a process 100 to implement robust digital image watermarking utilizing a Walsh transform algorithm, according to one embodiment of the present invention. To begin with, at block 110, the process receives a cover image and a watermark symbol. The cover image is then partitioned (block 120). Next, a key is generated (block 130). Based on the previous partitioning and the previously generated key, a watermark is inserted into the cover image utilizing a Walsh transform (block 140). Lastly, at block 150, the watermark is extracted from the watermarked cover image also utilizing a Walsh transform. Each of these individual process blocks will be discussed in more detail below.

The process at block 110 first receives the cover image and the watermark symbol. In one embodiment, the cover image (I) may be a gray-level image of size N×N where N=2^{P} and the digital watermark symbol or logo (L) may be a two level image of size M×M. In one embodiment, the digital watermark symbol is preferably 1/16 or 1/32 of the size of cover image. It should be noted that the smaller the size of a digital watermark symbol, a correspondingly smaller amount of pixel values are required to be embedded in the image and the robustness of the process is increased. For explanatory purposes, an example in which a binary image of size (16×16) will be utilized as a digital watermark symbol and a cover image of size (256×256), 8 bits/pixel gray image, will be utilized.

Also a brief description of the Walsh Transform will now be given. Assuming that there are N=2ⁿ number of points in a one dimensional discrete signal f (x) (where n is positive integer), the discrete Walsh transform (DWT) denoted by W (u) is defined as:

$$W ( u ) = \frac{1}{N} {\sum }_{x = 0}^{N - 1} f ( x ) {\prod }_{i = 0}^{n - 1} {( - 1 )}^{{b}_{\text{?}} ( x ) {b}_{\text{?}} ( u )}$$

$$\text{?} \text{indicates text missing or illegible when filed}$$

Where bₖ (z) is the k-th bit in binary representation of z. See, for example, Gonzalez and Woods, Digital Image Processing, Addison-Wesley, New York, 1992. Hence the forward kernel of the one-dimensional discrete Walsh transform may be expressed as:

$$g ( x , u ) = \frac{1}{N} {\prod }_{i = 0}^{n - 1} {( - 1 )}^{{b}_{\text{?}} ( x ) {b}_{\text{?}} ( u )}$$

$$\text{?} \text{indicates text missing or illegible when filed}$$

The Walsh transformation kernel is a symmetric matrix having orthogonal rows and columns. This property leads to an inverse kernel that is identical to forward kernel, except for the constant multiplicative factor of 1/N.

Accordingly, the inverse Walsh transform kernel is

$$h ( x , u ) = {\prod }_{i = 0}^{n - 1} {( - 1 )}^{{b}_{\text{?}} ( x ) {b}_{\text{?}} ( u )}$$

$$\text{?} \text{indicates text missing or illegible when filed}$$

and the inverse Walsh transform is

$$f ( x ) = {\sum }_{u = 0}^{N - 1} W ( u ) {\prod }_{i = 0}^{n - 1} {( - 1 )}^{{b}_{\text{?}} ( x ) {b}_{\text{?}} ( u )} . \\ \text{?} \text{indicates text missing or illegible when filed}$$

An advantage of the Walsh transformation over other unitary transforms, such as the Fourier transform, which have a kernel of complex exponential terms, is that the Walsh transform kernel consists of only a signed integer value +1 and −1, which does not require floating point multiplication during implementation.

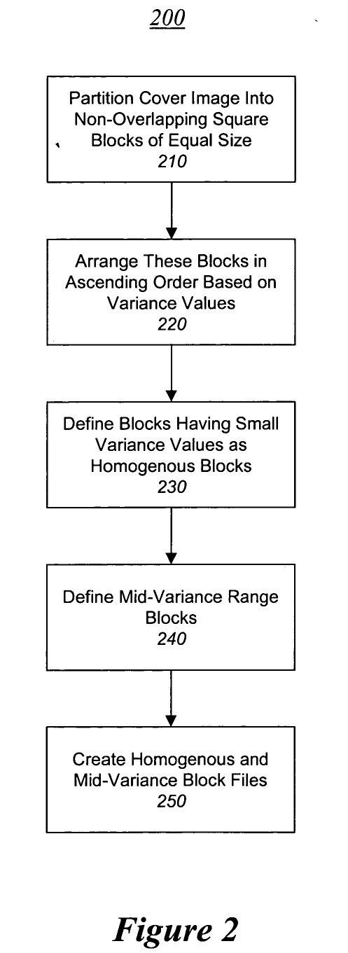

As previously discussed, the process at block 120 partitions the cover image. With reference to FIG. 2, FIG. 2 is a flow diagram that illustrates a process 200 to implement partitioning, according to one embodiment of the present invention. As shown in FIG. 2, the cover image may be partitioned into non-overlapping square blocks of equal size (block 210). Continuing with the present example, in which the cover image is of size (256×256), the cover image may be partitioned into non-overlapping square blocks of size (8×8) pixels. A block may be denoted by the location of its starting pixel (x, y). In this example, because the cover image is of size (256×256), a total number of 1024 of such blocks may be obtained for watermark symbol insertion.

Next, all such blocks are arranged in ascending order based on their variance values (block 220). Blocks having small variance values are defined as homogenous blocks (block 230). Of course, the smallness in variance value depends on the characteristics of image to be watermarked. In this example, the watermark symbol is (16×16) in size such that only 256 homogenous blocks are needed in order to insert one watermark pixel in each such homogenous block.

Further, mid-variance range blocks may also be defined (block 240). Continuing with the present example, another set of 256 blocks ranging from the (512−128)th position to the (512+128)th position (i.e. from the 384^{th} to 640^{th} position) in ascending order arrangement of variance are defined as mid-variance range blocks and may also hide one pixel of a watermark symbol in each such block.

In this way, a watermark symbol may also be inserted into two different sets of non-overlapping blocks to ensure redundant insertion of watermark pixels in the cover image. In order to aid in accomplishing this, two sets of files (e.g., look-up tables), termed a homogenous block file and a mid-variance file listing the location of homogenous blocks and mid-variance blocks, respectively, are created (block 250). These files are used in the insertion and extraction of watermark pixels through proper Walsh coefficients, as will be discussed.

Next, a key is generated (block 130 of FIG. 1, as previously discussed). Particularly, a pseudo-random number of suitable length is generated for use as the private key. Continuing with the present example, the length of the pseudo-random number for the private key would be 256. In one example, the pseudo-random number may be generated using a Linear Feedback Shift Register. See, for example, B Sklar, Digital Communication, Prentice Hall Englewood cliffs, N.J., 1998.

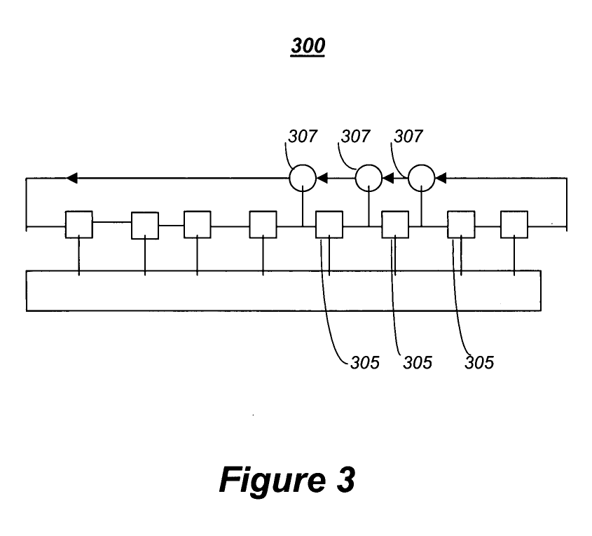

For example, the manner of generating the pseudo-random number may be best illustrated by the polynomial representation f(x)=x^{m}+aₘ₋₁x^{m-1}+aₘ₋₂x^{m-2}+a₁x+1 in which the coefficients (aᵢ) of the various powers of x are either zero or one. Looking briefly at FIG. 3, FIG. 3 is a schematic diagram illustrating an example of a shift register circuit 300. The shift register circuit 300 that describes this polynomial is shown in FIG. 3 in which the outputs of the various stages 305 are fed back to the input through weighting coefficients 307 a₁ through aₘ₋₁.

For the present example, to generate a pseudo-random number of length 256 a polynomial f(x)=x⁸+x⁶+x⁵+x⁴+1 may be considered with initial values of all eight shift register set to 1. In fact any combination of 0s and 1s, except all 0s, may be used as input for the shift registers. The output may be taken from all eight-shift registers at a time for each clock input and their decimal equivalent is the number that occurred at that clock input. This way a sequence of length 256 is generated. Continuing with the present example, a sequence (e.g. 45, 36, 10, 23 . . . 67) may be generated and this sequence may be used to permute the watermark to disperse the spatial relationship.

With the example sequence previously generated (i.e. 45, 36, 10, 23 . . . 67), spatial dispersion is implemented by inserting the 45th bit of the 1-D bit stream of the watermark symbol first, then the 36th bit, then the 10th bit, then the 23rd bit, etc. In this example, this spatially dispersed one-dimensional string of 1s and 0s when converted to two-dimensional data of size 16×16, is used to create a spatially dispersed watermark symbol, which is denoted as L₁ for descriptive purposes hereinafter.

Next, the spatially dispersed watermark symbol L₁ is inserted in the cover image utilizing a Walsh transform (block 140 of FIG. 1, as previously discussed). According to the homogenous block file and mid-variance file, which list the locations of homogenous blocks and mid-variance blocks, respectively, blocks from the cover image are selected and the Walsh transformation is applied to these blocks. In the present example, the blocks are (8×8).

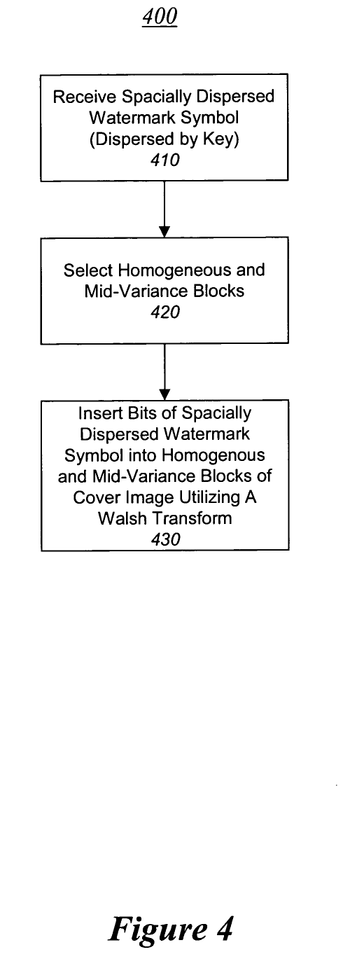

With reference now to FIG. 4, FIG. 4 is a flow diagram illustrating a detailed process 400 to implement robust digital image watermarking utilizing a Walsh transform algorithm, according to one embodiment of the present invention. Particularly, as detailed in FIG. 4, at block 410 the spatially dispersed watermark symbol L₁, which as previously discussed is dispersed in accordance with the previously generated pseudo-random private key, is received. Next, a plurality of homogenous blocks and mid-variance blocks are selected (block 420). Based on this data, bits of the spatially dispersed watermark symbol L₁ are inserted into homogenous and mid-variance blocks, respectively, of the cover image utilizing a Walsh transform. Particular details of this process are discussed below.

Continuing with the present example, for an (8×8) block from the homogenous block file, a pixel from spatially dispersed watermark symbol L₁ is inserted as the DC coefficient or mean value of the Walsh transformation, e.g. the W (0,0) value of such block. For example, let the integer part of W (0,0) be A (0,0). The bit plane representation of A (0,0) requires at most 8 binary digits for a gray-level image. Assume that the bit plane representation of A (0,0) is denoted by S₈, S₇, S₆, S₅, S₄, S₃, S₂, and S₁. One pixel from L₁ replaces a particular bit (e.g. preferably Least Significant Bit planes S₃ or S₂ or S₁) in the bit plane representation of A (0,0) for each homogenous block.

Similarly, in each block of mid-variance range from the mid-variance block file, the highest Walsh coefficients, other than DC coefficient, are used to hide one pixel from the spatially dispersed watermark symbol L₁. The insertion of watermark pixels is done in the same way as described above for homogenous blocks.

For both the homogenous and mid-variance blocks, the selection of a particular bit in the bit plane representation may be determined based on the local characteristics (e.g. the busyness and/or smoothness of regions) of the block (i.e. sub-image) in the cover image. For example, a heuristic approach for such bit position selection for both regions may be used. This heuristic approach may alternatively be governed by the global characteristics of the cover image besides the local properties of a candidate block or in addition thereto.

Furthermore, in connection with selection of proper bit position for watermark insertion, the chosen bit position should not be fixed for the entire range of variance in either zone (i.e. the homogenous or mid-variance zones). Bit position selection instead should depend on a variance value of a candidate block. For example, in one embodiment, in either zone (homogenous or mid-variance) the range of variance values may be divided into different disjoint sub-bands and a particular bit position may be assigned for each such sub-band.

Continuing with the present example, variance values for homogenous blocks may range from 0 to 15 and this range is divided into three disjoint sub-bands, for example: 0-5, 5-10, and 10-15, etc. For blocks with variance value in the range 0-5, S₁ may be used to hide a watermark pixel, S₂ for blocks with variance value in the range 5-10 may be used to hide a watermark pixel, S₃ for blocks with variance value in the range 10-15 may be used to hide a watermark pixel, etc.

The higher the value of variance of a particular sub-band within the variance range, the higher the bit position in bit plane representation that is needed and is used for watermark insertion of the spatially dispersed watermark symbol L₁. Thus, for watermark insertion in variable bit positions of Walsh coefficients, two other data files are formed, namely a bit positions for homogenous blocks file and a bit positions for mid-variance blocks file, which record the position of a selected bit for each block for both the homogenous and mid-variance blocks, respectively. These may be in the form of look-up tables, for example. Particularly, the bit positions for mid-variance blocks file also keeps the actual position of the highest Walsh coefficient within the block. The positional information of the bit positions for homogenous blocks and bit positions for mid-variance blocks files are used to help to extract the watermark symbol from the proper bit position of Walsh coefficients, as will be discussed.

It should be noted that the choice of a higher order LSB plane (e.g. 4^{th} or higher from the bottom plane, i.e., S₈, S₇, S₆, S₅, S₄), instead of the LSB plane, for watermark insertion of the spatially dispersed watermark symbol may result in more robust watermarking at the cost of visual distortion of the cover image.

In order to minimize this aberration and for possible survival of the embedded information from the effect of the possible attack like low pass filtering further bit manipulation is made for Walsh coefficients used in the watermark insertion of the spatially dispersed watermark symbol. Implementation of this scheme may be done in anticipation of possible change of data attacks like mean filtering. In order to accomplish this, fractional parts of Walsh coefficients are used in watermark insertion and are appended with their corresponding integer parts.

An inverse Walsh transformation is then applied for all blocks used to hide a watermark pixel of the spatially dispersed watermark symbol and are placed in their respective position in the cover image. The watermarked data thus obtained for the cover image is further low pass filtered, for example using a mask of size (7×7) pixels. This larger sized spatial mask used in such an operation makes the data insertion perceptually invisible, because the eye acts as a spatial low-pass filter.

Continuing with the present example, assume an A (0, 0) value for a homogenous block before and after low pass filtering of an intermediate watermarked image A₁ (0, 0) and A₂ (0, 0), respectively, and assuming that watermark pixel is inserted in third Least Significant Bit (LSB) position, i.e. S₃, in the bit plane representation of A (0, 0) for a particular block.

Further, continuing with present example, where 3 LSBs of A₁ (0, 0), i.e., S₃, S₂ S₁ are 1, 1, and 0, respectively, three possible manipulations may be implemented as follows:
(a) If A₂ (0, 0)>A₁ (0, 0) then two LSBs of A₁ (0, 0), i.e., S₂ and S₁ are forced to “0” converting the three LSBs of A₁ (0, 0) as 100, i.e. S₃ S₂ S₁ now become 100.
(b) If A₂ (0, 0)<A₁ (0, 0) then two LSBs of A₁ (0, 0), i.e., S₂ and S₁ are forced to “1” converting the three LSBs of A₁ (0, 0) as 111, i.e., S₃ S₂ S₁ now become 111.
(c) If A₂ (0, 0)=A₁ (0, 0) no data manipulation is done, i.e., gray values of all pixels of the current blocks thus obtained remain unchanged, i.e., A₁ (0, 0) as 110.

The manipulation for other combinations of lower bit planes may also be accomplished in the same way. The manipulation of Walsh coefficients used for insertion of a watermark pixel of a spatially dispersed watermark symbol in mid-variance blocks is also done in same way as described for homogenous blocks. Next, a block-based inverse Walsh transformation is then applied in all such blocks and is placed in proper position of the cover image. This completes the watermark insertion of the watermark symbol.

It should be noted that blocks not used in watermark insertion remain unchanged throughout the data hiding process. Only the blocks of the type that are in vicinity of homogenous or mid variance-blocks may have a major contribution in manipulation of Walsh coefficients used in watermark insertion of the watermark symbol; but the data values of such blocks in the actual watermarked image and in the cover image itself remain completely unchanged. By inserting the same watermark symbol in different regions of a cover image redundancy in the hidden information is ensured.

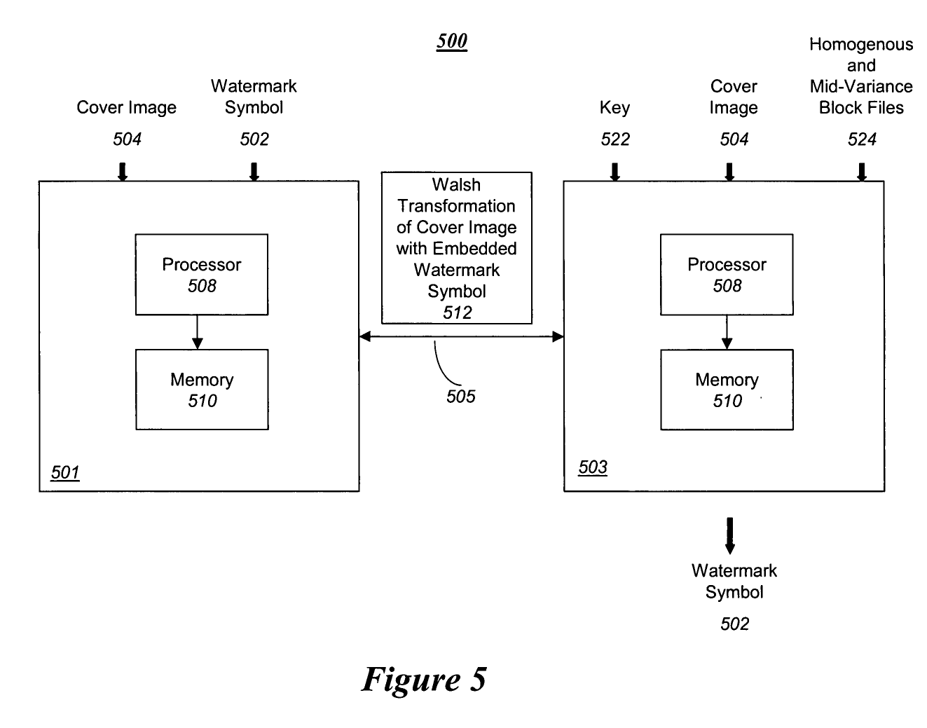

Turning now to FIG. 5, FIG. 5 shows a block diagram 500 illustrating the extraction of a watermark symbol from a watermarked cover image, according to one embodiment of the invention. Particularly, FIG. 5 illustrates the last step of the previously-described process in which the watermark symbol 502 is extracted from the cover image 504 (block 150 of FIG. 1, as previously discussed).

As shown in FIG. 5, two image processing platforms 501 and 503 may be communicatively coupled to one another via a link 505. The link 505 may be broadly defined as one or more physical or virtual information carrying mediums that establish a communication pathway such as, for example, optical fiber, electrical wire, cable, bus traces, wireless channels (e.g. radio, satellite frequency, etc.) and the like. For example, the link may include a computer network (e.g. a wide area network (WAN), the Internet, a Local Area Network (LAN)) used to transfer digital data traffic utilizing Internet Protocol (IP), Asynchronous Transfer Mode (ATM), Frame Relay (FR), Point-to Point Protocol (PPP),or any other sort of protocol. Data traffic through the network may be of any type including voice, graphics, video, audio, e-mail, fax, text, multi-media, documents and other generic forms of data.

The image processing platforms 501 and 503 may be any sort of computing or networking device (e.g. personal computer, network computer, server, copier, fax, lap-top computer, mobile computing device, cell-phone, etc.). Such computing or networking devices may include a processor 508, a memory 510, input/output devices, etc. The two image processing platforms 501 and 503 may also just be integrated circuits. It should be appreciated that the image processing platforms 501 and 503 may be any sort of device or machines capable of implementing instructions.

In this example, the image processing platform 501 implements the previously-described processes relating generally to receiving a cover image 504 and a watermark symbol 502, generating a key, embedding the watermark symbol into the cover image utilizing a Walsh transform and the previously-described techniques, and further transmitting the Walsh transformation of the cover image with the embedded water mark symbol 512 via link 505 to the second image processing platform 503.

The second image processing platform 503 receives the Walsh transformation of the cover image with the embedded water mark symbol 512 from the first image processing platform 501.

The second image processing platform 503 also receives the key 522 and either the cover image 504 and/or the homogenous and mid-variance block files 524, previously discussed. The homogenous and mid-variance block files 524 include the homogenous block data file and the mid-variance data file listing the location of homogenous blocks and mid-variance blocks, respectively, and the bit positions for homogenous blocks data file and the bit positions for mid-variance blocks data file, which record the position of a selected bit for each block for both the homogenous and mid-variance blocks, respectively, all four of which have been previously discussed in detail. The second image processing platform 503 may receive these items from the first image processing platform 501 or from other sources.

Based on this received data, the second image processing platform 503 can extract the watermark symbol 502 from the watermarked cover image to verify its authenticity.

The extraction of the watermark symbol 502 by the second image processing platform requires both the original cover image 504 and the key 522 used to permute the spatial relationship of the watermark symbol before its insertion into the cover image 504, as previously discussed.

Since the private key 522 is required, embodiments of the invention for robust digital image watermarking techniques utilizing a Walsh transform algorithm relate to the class private watermarking techniques.

Further, in some embodiments, along with private key 522 either the original cover image 504, or, the homogenous and mid-variance block files 524 (including the previously-discussed data files related to the homogenous block file, mid-variance block file, the bit positions for the homogenous blocks file, and the bit positions for the mid-variance blocks file) are required in order to locate the position of the watermark symbol 502 in a possibly distorted watermarked image 512 and to extract the watermark symbol 502 from the possibly distorted watermarked image 512 during watermark extraction at distant place, such as image processing platform 503. The watermark symbol 502 may be extracted from the watermarked image 512 (i.e. the Walsh transformation of the cover image with the embedded watermark symbol) by the reverse or inverse of the previously-described process used to embed the watermark symbol using the Walsh transformation in the cover image.

Continuing with the previous example, the watermarked image 512 under inspection, has been divided or partitioned into non-overlapping block of size 8×8 pixels, as previously discussed.

During the extraction process, a homogenous block of the watermarked image 512 (currently under inspection) that belongs to the look-up table (i.e. data file) related to homogenous blocks is examined for watermark extraction. Block-based Walsh transformation is applied for all such homogenous blocks by interrogating the look-up table (i.e. data file) for bit positions for the homogenous blocks file and in this way one watermark pixel is extracted from bit plane representation of A (0, 0) value for each homogenous block. In this way, the same spatially dispersed watermark symbol is extracted from the possibly distorted watermarked image 512 (including a watermarked image after some external attack).

Similarly, the watermark symbol 502 can also be extracted from the mid-variance blocks of the watermarked image 512 under inspection. During the extraction process, a mid-variance range block of the watermarked image 512 (currently under inspection) that belongs to the look-up table (i.e. data file) related to mid-variance blocks is examined for watermark extraction. Block-based Walsh transformation is applied for all such mid-variance blocks by interrogating the look-up table (i.e. data file) for the bit positions for the mid-variance blocks file and in this way one watermark pixel is extracted from the bit plane representation of the integer part of highest Walsh coefficients W (x, y) value. In this way the same spatially dispersed watermark symbol is extracted from the possibly distorted watermarked image 512 (including a watermarked image after some external attack).

Further, in this way, the same spatially dispersed watermark symbol is extracted from two different zones (i.e. homogenous zones and mid-variance zones) of the possibly distorted watermarked image 512.

The spatially dispersed watermark symbol thus obtained from either zone (i.e. homogenous zones or mid-variance zones) is once again permuted using the same key 522 (pseudo-random number) used earlier to permute the spatial relationship of the watermark and watermark symbol 502 in its original form is thus obtained. This completes watermark extraction process.

It appears that a watermark symbol inserted into two different zones (i.e. homogenous zones or mid-variance zones) of the cover image 504 shows different degree of robustness to different type of attacks, as will be discussed below. Between two watermark symbols 502, extracted from the two different zones, the better one on the basis of visual quality may be considered as the best authentication mark in a particular situation.

Thus, embodiments of the present invention provide for computationally efficient private digital image watermarking utilizing Walsh coefficients. An advantage of the Walsh transformation over other unitary transforms, such as the Fourier transform, which have a kernel of complex exponential terms, is that the Walsh transform kernel consists of only a signed integer value +1 and −1, which does not require floating point multiplication during implementation. Thus, the Walsh transform is computationally efficient.

Another advantage is that while the spatial mid-frequency zone of the cover image is used to hide watermark symbol information in order to optimize the trade off between watermark transparency and robustness against lossy data compression like Joint Photographic Experts Group (JPEG); watermark symbol insertion also occurs in the spatial low frequency zone or homogenous zone of the image, which shows high resiliency against common signal processing operations like mean and median filtering. Accordingly, redundancy in distribution of the hidden watermark symbol information occurs in two different non-overlapping zones of the cover image to accommodate the effect of various types of external attacks. Redundancy in hidden watermark symbol information also ensures watermark extraction even from a truncated or incomplete watermarked image.

Along with resiliency to common signal processing operations like mean filtering, median filtering, lossy data compression like JPEG with compression ratios, and low Peak Signal to Noise Ratio (PSNR) values, the previously described process provides robustness to symmetric image cropping, random and deliberate lower order bit plane(s) manipulation of gray values, and changes in the dynamic ranges of gray levels tested over large number of bench marking images as suggested by watermarking community.

It will, of course, be understood that, although particular embodiments have just been described, the claimed subject matter is not limited in scope to a particular embodiment or implementation. For example, one embodiment may be in hardware, whereas another embodiment may be in software. Likewise, an embodiment may be in firmware, or any combination of hardware, software, or firmware, for example. Likewise, although the claimed subject matter is not limited in scope in this respect, one embodiment may comprise an article, such as a storage medium. Such a storage medium, such as, for example, a CD-ROM, or a disk, may have stored thereon instructions, which when executed by a system, such as a computer system or platform, or an imaging system, for example, may result in an embodiment of a method in accordance with the claimed subject matter being executed, such as an embodiment of a method for robust digital image watermarking techniques utilizing a Walsh transform algorithm, for example, as previously described. For example, an image processing platform system may include an integrated circuit, a processing unit, an input/output device and/or memory, etc.

Further, while embodiments of the present invention and its various functional components have been described in particular embodiments, it should be appreciated that the embodiments of the present invention can be implemented in hardware, software, firmware, middleware or a combination thereof and utilized in systems, subsystems, components, or sub-components thereof.

When implemented in software or firmware, the elements of the present invention are the instructions/code segments to perform the necessary tasks. The program or code segments can be stored in a machine readable medium (e.g. a processor readable medium or a computer program product), or transmitted by a computer data signal embodied in a carrier wave, or a signal modulated by a carrier, over a transmission medium or communication link. The machine-readable medium may include any medium that can store or transfer information in a form readable and executable by a machine (e.g. a processor, a computer, etc.). Examples of the machine-readable medium include an electronic circuit, a semiconductor memory device, a ROM, a flash memory, an erasable programmable ROM (EPROM), a floppy diskette, a compact disk CD-ROM, an optical disk, a hard disk, a fiber optic medium, a radio frequency (RF) link, etc. The computer data signal may include any signal that can propagate over a transmission medium such as electronic network channels, optical fibers, air, electromagnetic, RF links, bar codes, etc. The code segments may be downloaded via networks such as the Internet, Intranet, etc.

Additionally, while embodiments of the invention have been described with reference to illustrative embodiments, these descriptions are not intended to be construed in a limiting sense. Various modifications of the illustrative embodiments, as well as other embodiments of the invention, which are apparent to persons skilled in the art to which embodiments of the invention pertain, are deemed to lie within the spirit and scope of the invention.

Results

Correlation Measurement

Because embodiments of the invention related to robust digital image watermarking techniques utilizing a Walsh transform algorithm are utilized to hide a recognizable pattern such as a watermark symbol, the visual degradation of the extracted watermark symbol may be compared with reference to the original watermark symbol. The subjective measurement of the degradation of the extracted watermark symbol depends on viewer expertise, the nature of the operations performed, sometimes the structure of watermark symbol itself, and the local and global characteristics of the cover image to be watermarked, and the experimental conditions. A quantitative measurement of the extracted watermark symbol image fidelity may be measured between the original or reference watermark symbol L and the extracted watermark symbol L′ by a normalized cross correlation (NCC) where:
NCC=ΣxΣy L(x, y)L′(x, y)/ΣxΣy[L(x,y)]2;
which is the cross correlation normalized by the watermark energy to give a maximum value of NCC as unity.

### EXAMPLES

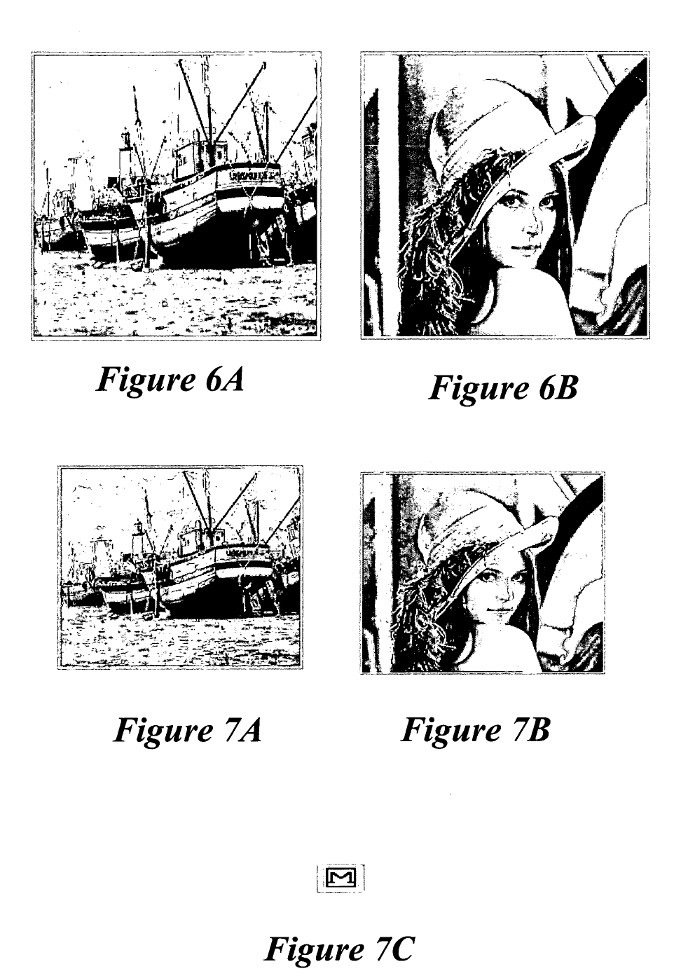

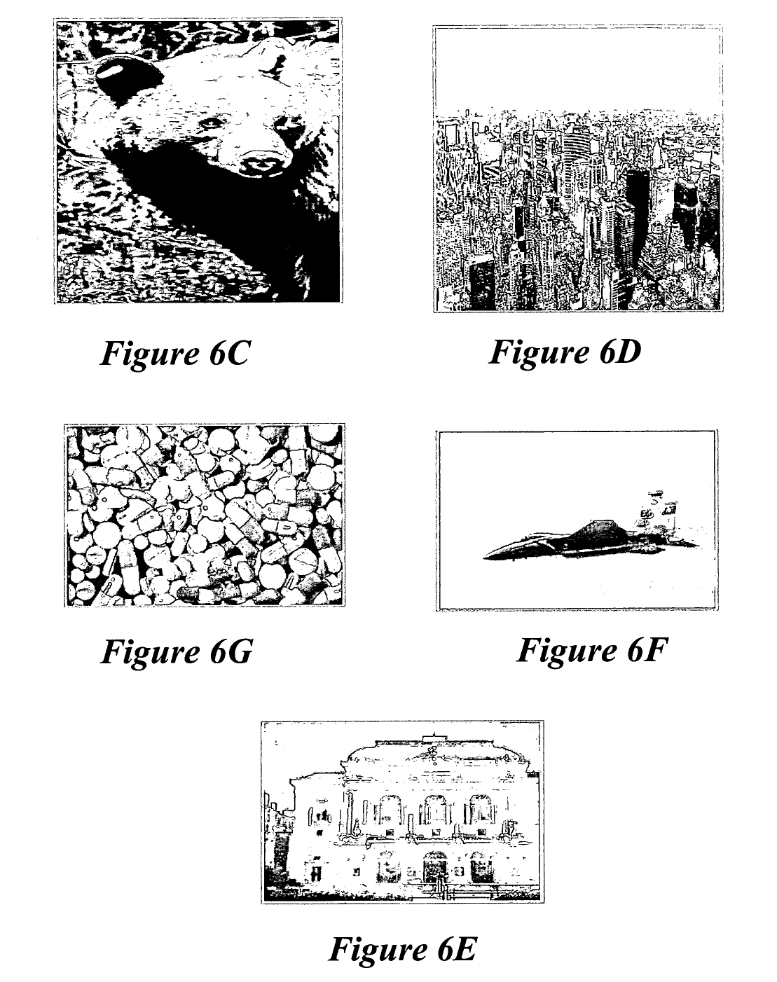

FIGS. 6A and 6B are images showing a fishing boat and a women (named Lena, hereinafter referred to as the “Lena image”), respectively, used as test cover images, and FIGS. 7A and 7B are the watermarked images of FIGS. 6A and 6B, respectively, using a watermark symbol “M” as shown in FIG. 7C, using the previously described embodiments of the invention for robust digital image watermarking techniques utilizing a Walsh transform. Test results show that the Peak Signal to Noise Ratio (PSNR) of the watermark images FIGS. 7A and 7B to the cover images FIGS. 6A and 6B are about 36.00 dB and 37.80 dB, respectively. Therefore, quality degradations of the watermarked image could hardly be perceived by the human eye.

Further, robustness to different possible signal processing operations will later be discussed with reference to respective tables for five test images: a bear, New York, an opera, a F151 fighter aircraft, and pill images. These test images are shown as FIGS. 6C, 6D, 6E, 6F, and 6G, respectively.

Mean Filtering Operation

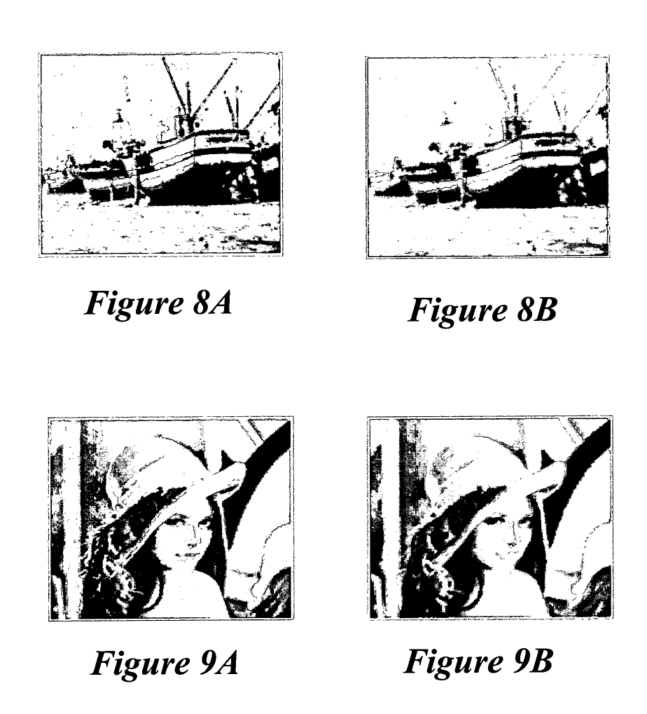

Images are sometime smoothed using a mask of suitable size to remove spurious effect that may occur as a result of sampling, quantization or because of poor transmission channel, etc. FIGS. 8A and 8B show blurred versions of a watermarked fishing boat image after first and second time mean filtering, respectively, using a 3×3 window. The PSNR values corresponding to FIGS. 8A and 8B are 25.32 dB and 23.62 dB, respectively, wherein FIGS. 8C and 8D show an extracted watermark symbol with NCC=0.98 and NCC=0.83 respectively, which were extracted using the previously described embodiments of the invention for robust digital image watermarking techniques utilizing a Walsh transform from FIGS. 8A and 8B, respectively. The extracted watermark symbol is found to be still recognizable.

Similarly, FIGS. 9A and 9B show blurred versions of a watermarked Lena image after first and second time mean filtering, respectively. The PSNR values corresponding to FIGS. 9A and 9B are 27.75 dB and 25.60 dB, respectively, wherein FIGS. 9C and 9D show an extracted watermark symbol with NCC=1.00 and NCC=0.88, respectively, which were extracted using the previously described embodiments of the invention for robust digital image watermarking techniques utilizing a Walsh transform from FIGS. 9A and 9B, respectively. The extracted watermark symbols, although disturbed by noise, is still recognizable

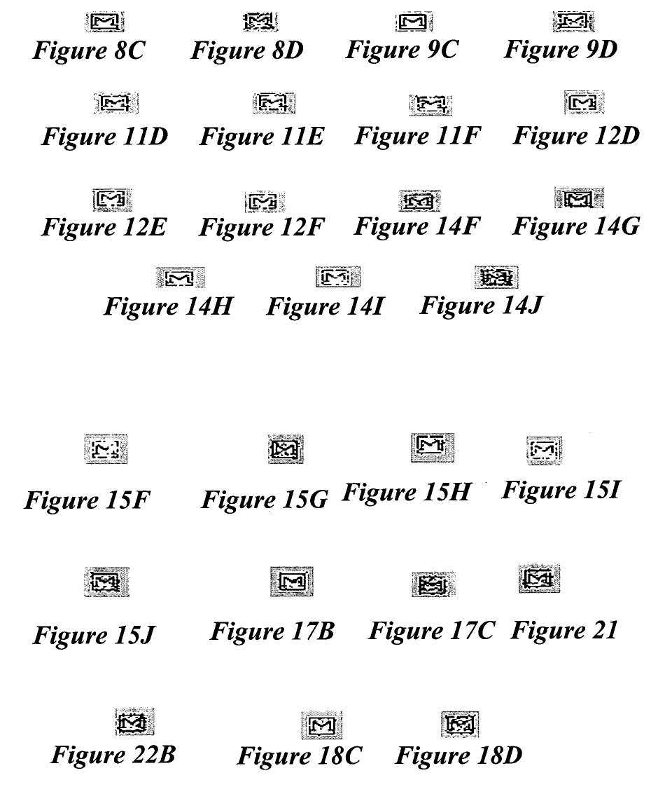

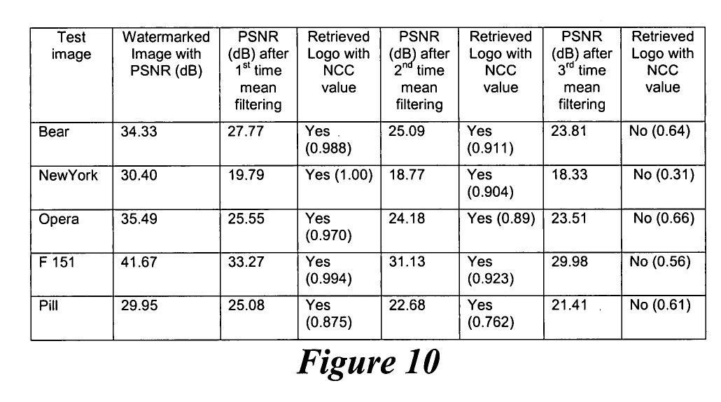

FIG. 10 shows a table of test results of the robustness to mean filtering for the other five test images when utilized with embodiments of the invention for robust digital image watermarking techniques utilizing a Walsh transform.

Median Filtering Operation

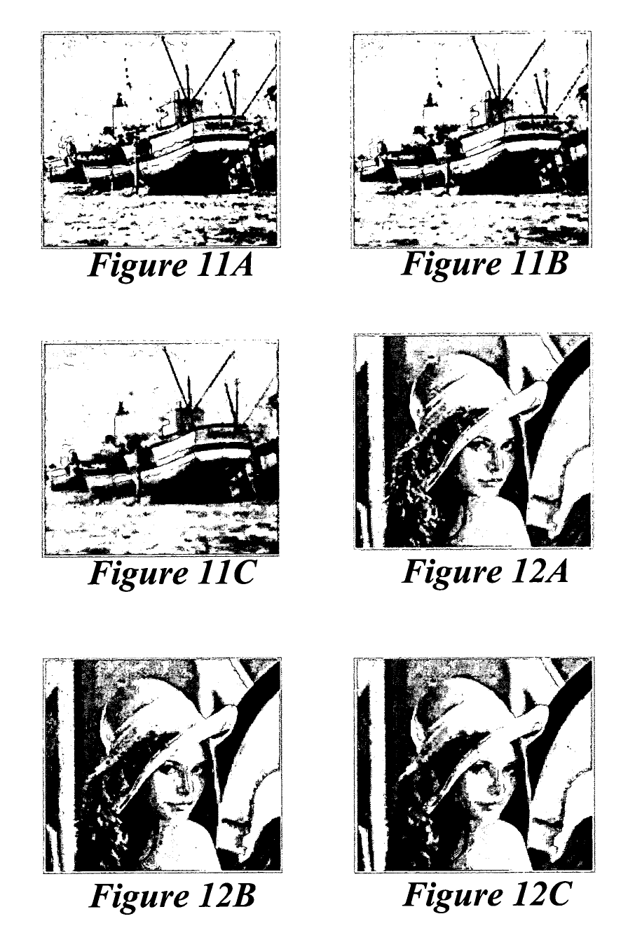

To reduce significantly the blurring effect, median filtering is applied to images, the principal functioning of which is to eliminate intensity spikes that appear isolated in the area of the filter mask. FIGS. 11A, 11B, and 11C show watermarked fishing boat images after 1st, 2nd and 5th time median filtering. The PSNR values corresponding to FIGS. 11A, 11B, and 11C are 25.99 dB, 25.56 dB and 24.55 dB, respectively. Extracted watermark symbols are shown in FIGS. 11D, 11E, and 11F with their NCC values of 0.946, 0.949 and 0.93, respectively, which were extracted using the previously described embodiments of the invention for robust digital image watermarking techniques utilizing a Walsh transform from FIGS. 11A, 11B, and 11C, respectively. The extracted watermark symbols in all cases are fully recognizable although they are interfered with noise by different amounts.

Similarly, FIGS. 12A, 12B, and 12C show watermarked Lena images after 1st, 2nd and 5th time median filtering. The PSNR values corresponding to FIGS. 12A, 12B, and 12C are 29.49 dB, 28.89 dB and 27.76 dB, respectively. Extracted watermark symbols are shown in FIGS. 12D, 12E, and 12F with their NCC values of 0.994, 0.988 and 0.797, respectively, which were extracted using the previously described embodiments of the invention for robust digital image watermarking techniques utilizing a Walsh transform from FIGS. 12A, 12B, and 12C, respectively. The extracted watermark symbols in all cases are fully recognizable although they are interfered with noise by different amounts.

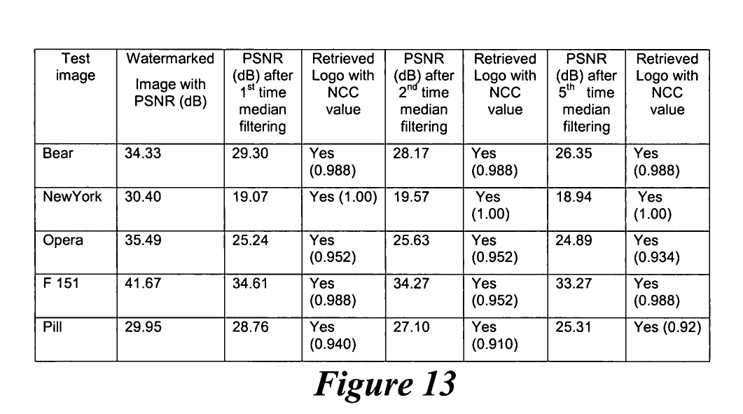

FIG. 13 shows a table of test results of the robustness to median filtering for the other five test images when utilized with embodiments of the invention for robust digital image watermarking techniques utilizing a Walsh transform.

Image Cropping Operation

The robustness of the previously-described embodiments of the invention for robust digital image watermarking techniques utilizing a Walsh transform against different types of image cropping operations that may be performed, for example, as a deliberate external attack, on the watermarked image has also been tested. Because the watermark pixels of the watermark symbol are inserted with sufficient redundancy in the cover image, it is difficult for an outsider to detect or remove the watermark symbol by cutting some part of the cover image. So it is still possible to extract the watermark symbol with recognizable quality even from a truncated watermarked image.

Image cropping operations have been simulated by altering data with arbitrary values (e.g. 150) in a quarter of a watermarked image in upper left, upper right, lower left and lower right one at a time, and in all cases, the extracted watermark symbol, although interfered by noise by different amount, was still recognizable.

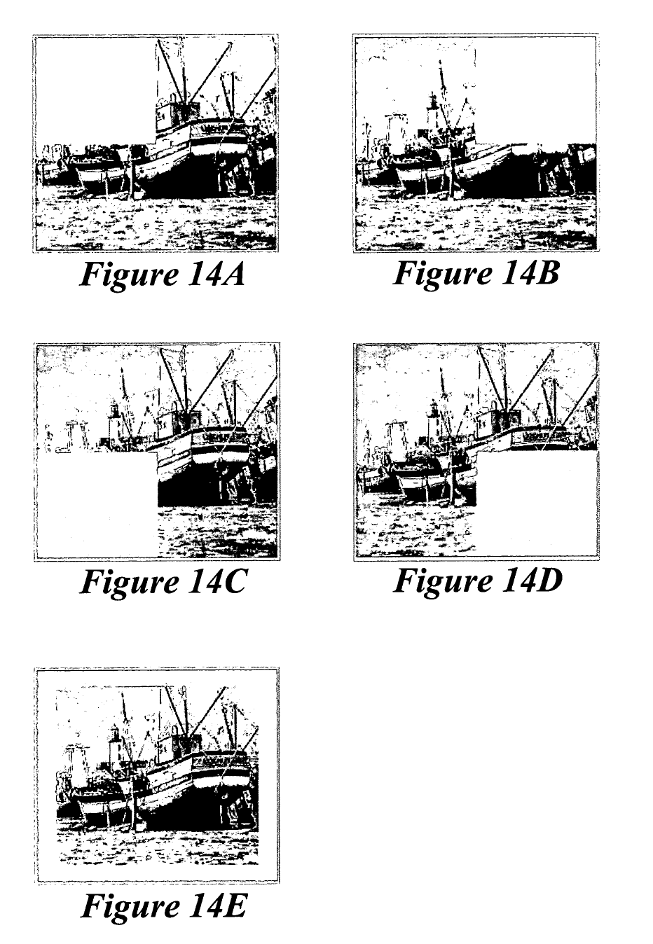

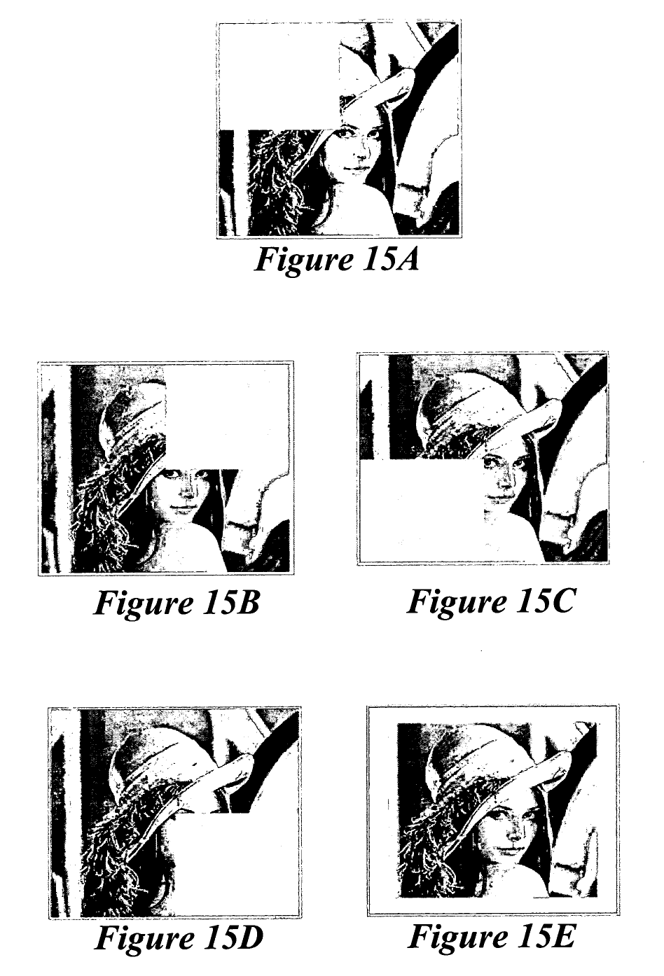

FIGS. 14A, 14B, 14C, and 14D show a watermarked fishing boat image with the image cropping operation as mentioned earlier and their PSNR values of 26.11 dB, 21.13 dB, 20.05 dB and 16.85 dB, respectively. Extracted watermark symbols with their NCC values 0.84, 0.86, 1.0 and 1.0, respectively, are shown in FIGS. 14F, 14G, 14H, and 14I respectively, which were extracted using the previously described embodiments of the invention for robust digital image watermarking techniques utilizing a Walsh transform from FIGS. 14A, 14B, 14C, and 14D, respectively. In all cases the extracted watermark symbol, although interfered by noise by different amounts, were still recognizable. The same operations were performed for watermarked Lena image and are shown in 15A, 15B, 15C, and 15D, respectively, with their PSNR values of 21.13 dB, 19.16 dB, 16.80 dB, and 19.84 dB respectively. Extracted watermark symbols with their NCC values 0.98, 0.82, 0.97 and 1.00 respectively, are shown in FIGS. 15F, 15G, 15H, and 15I, respectively, which were extracted using the previously described embodiments of the invention for robust digital image watermarking techniques utilizing a Walsh transform from FIGS. 15A, 15B, 15C, and 15D respectively. In all cases the extracted watermark symbol, although interfered by noise by different amounts, were still recognizable.

Image cropping operations have also been simulated by altering the pixel values of 20 rows and columns from the border of an image with some arbitrary value (e.g., 150). FIG. 14E shows a watermarked fishing boat image (PSNR=21.08 dB) with such an operation and an extracted watermark symbol with NCC=0.60 shown in FIG. 14J. FIG. 15E shows a similar type of image cropping operation for a watermarked Lena image with PSNR value 18.75 dB and an extracted watermark symbol with NCC=0.79 shown in FIG. 15J.

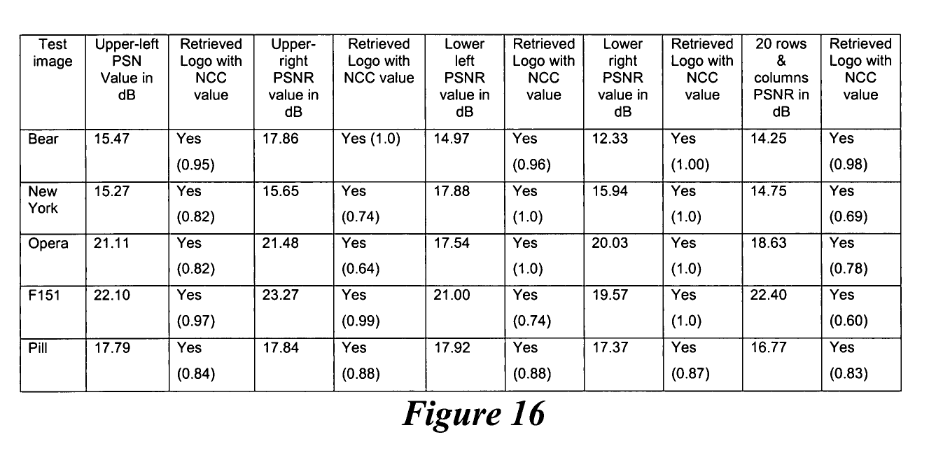

FIG. 16 shows a table of test results of the robustness to different types of image cropping operations for other five test images when utilized with embodiments of the invention for robust digital image watermarking techniques utilizing a Walsh transform.

JPEG Compression

Experimental test results show that when utilized with embodiments of the invention for robust digital image watermarking techniques utilizing a Walsh transform that as the compression ratio increases, the NCC value of the extracted watermark decreases and the quality of the extracted watermark will also decrease accordingly. Further, experimental test results show that watermark information hidden in the mid-variance blocks of the cover image remains almost unaffected even after JPEG compression with high compression ratio and low PSNR values. Thus, embodiments of the invention provide for a high-level robustness even with JPEG compression.

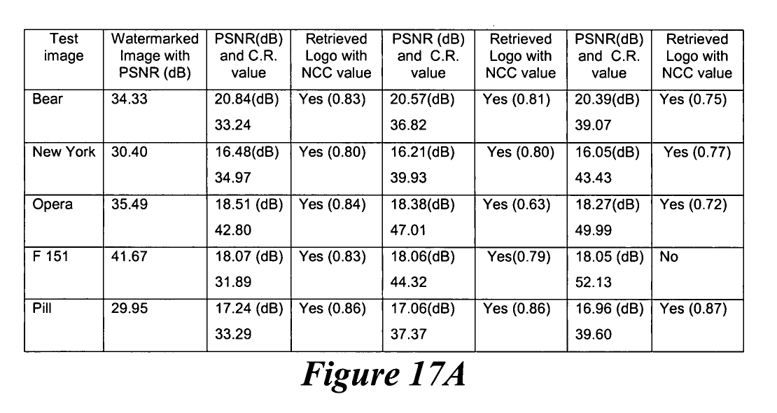

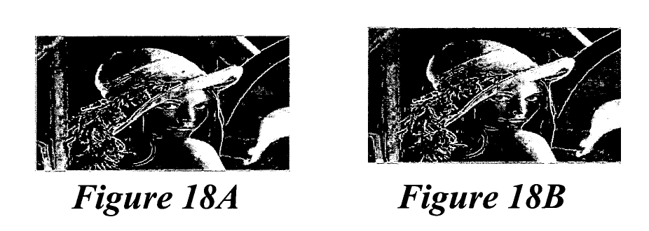

FIG. 17A shows a table of test results of the robustness to JPEG compression for the other five test images when utilized with embodiments of the invention for robust digital image watermarking techniques utilizing a Walsh transform. FIGS. 17B and 17C are the extracted watermark symbol after decompression from the JPEG compressed images of FIG. 7A with compression ratios of 31.80 and 44.56, respectively.

Deliberate Least Significant Bits Manipulation

Least significant bits for all the pixels, or randomly selected pixels, of the watermarked image were complemented and the extracted watermark symbol was still found to be of good quality up to a certain degree of bit alteration, using embodiments of the invention for robust digital image watermarking techniques utilizing a Walsh transform. FIGS. 18A and 18B show a watermarked Lena image that has undergone this operation with PSNR values of 47.71 dB and 34.47 dB, respectively. Extracted watermark symbols are shown in FIGS. 18C and 18D, with NCC values 0.95 and 0.79, respectively, which were extracted using the previously described embodiments of the invention for robust digital image watermarking techniques utilizing a Walsh transform from FIGS. 18A and 18B, respectively.

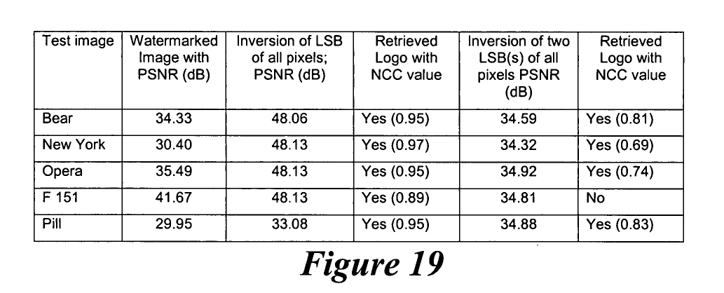

FIG. 19 shows a table of test results of the robustness to deliberate least significant bits manipulation for the other five test images when utilized with embodiments of the invention for robust digital image watermarking techniques utilizing a Walsh transform.

Change of Gray Level Dynamic Range

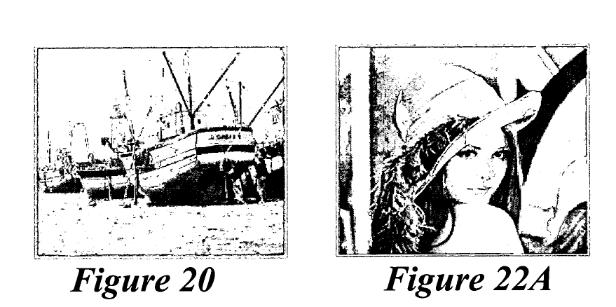

In some cases, there may be an intentional approach to remove a watermark symbol by changing the gray level dynamic range of the watermarked image. One such approach for the watermarked fishing boat image was tested for and is shown in FIG. 20, which was done by changing the dynamic range from 1-255 to 50-200. The PSNR value of the watermarked image after such operation to the original watermarked image is 21.99 dB and the extracted watermark symbol is shown in FIG. 21 with NCC=0.92, which was extracted using the previously described embodiments of the invention for robust digital image watermarking techniques utilizing a Walsh transform from FIG. 20.

Another case was also tested, where the dynamic range of gray level for the watermarked Lena image was changed from 22-243 to 200-50. The PSNR value of the watermarked image after such operation to the original watermarked image is 23.42 dB and is shown in FIG. 22A. The extracted watermark symbol is shown in FIG. 22B, which was extracted using the previously described embodiments of the invention for robust digital image watermarking techniques utilizing a Walsh transform from FIG. 22A.

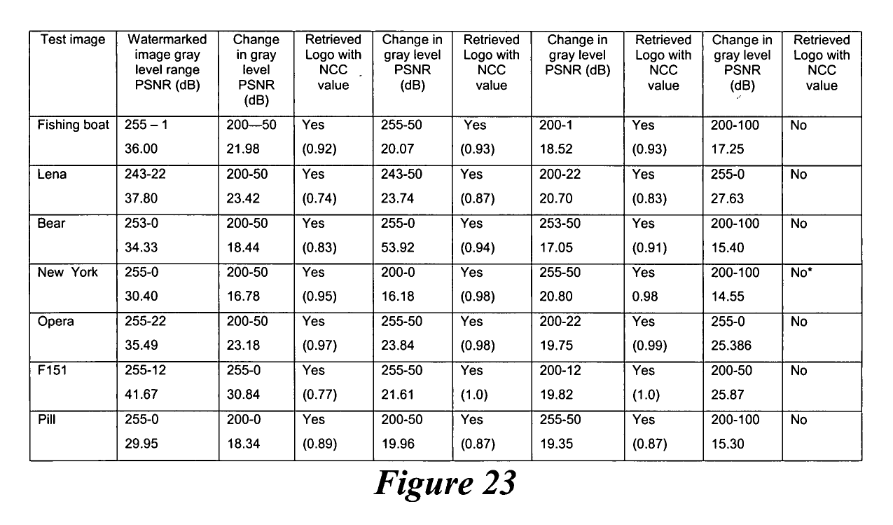

FIG. 23 shows a table of test results of the robustness to different possible changes in gray level dynamic range for the other five test images when utilized with embodiments of the invention for robust digital image watermarking techniques utilizing a Walsh transform.

1. A method comprising:
partitioning a cover image;
generating a key;
inserting a watermark symbol into the cover image utilizing a Walsh transform and the key; and
extracting the watermark symbol from the cover image utilizing a Walsh transform and the key.

2. The method of claim 1, wherein generating the key includes generating a pseudo-random number.

3. The method of claim 2, wherein the key is a private key.

4. The method of claim 1, wherein the watermark symbol is a logo.

5. The method of claim 1, wherein partitioning a cover image includes partitioning the cover image into non-overlapping blocks of equal size.

6. The method of claim 5, further comprising:
defining blocks having small variance values as homogenous blocks; and
defining blocks having mid-variance values as mid-variance blocks.

7. The method of claim 6, further comprising:
spatially dispersing the watermark symbol utilizing the key; and
selecting homogenous blocks and mid-variance blocks.

8. The method of claim 7, wherein inserting the watermark symbol into the cover image utilizing a Walsh transform and the key includes inserting bits of the spatially dispersed watermark symbol into the homogenous and mid-variance blocks of the cover image utilizing a Walsh transform.

9. The method of claim 8, wherein extracting the watermark symbol from the cover image includes extracting bits of the spatially dispersed watermark symbol from the homogenous and mid-variance blocks of the cover image utilizing a Walsh transform and the key.

10. An apparatus comprising:
an integrated circuit; and
a processor included with the integrated circuit to implement operations including:
partitioning a cover image;
generating a key;
inserting a watermark symbol into the cover image utilizing a Walsh transform and the key; and
extracting the watermark symbol from the cover image utilizing a Walsh transform and the key.

11. The apparatus of claim 10, wherein generating the key includes generating a pseudo-random number utilizing a shift-register circuit.

12. The apparatus of claim 11, wherein the key is a private key.

13. The apparatus of claim 10, wherein the watermark symbol is a logo.

14. The apparatus of claim 10, wherein partitioning a cover image includes partitioning the cover image into non-overlapping blocks of equal size.

15. The apparatus of claim 14, wherein the processor further performs the operations of:
defining blocks having small variance values as homogenous blocks; and
defining blocks having mid-variance values as mid-variance blocks.

16. The apparatus of claim 15, wherein the processor further performs the operations of:
spatially dispersing the watermark symbol utilizing the key; and
selecting homogenous blocks and mid-variance blocks.

17. The apparatus of claim 16, wherein inserting the watermark symbol into the cover image utilizing a Walsh transform and the key includes inserting bits of the spatially dispersed watermark symbol into the homogenous and mid-variance blocks of the cover image utilizing a Walsh transform.

18. The apparatus of claim 17, wherein extracting the watermark symbol from the cover image includes extracting bits of the spatially dispersed watermark symbol from the homogenous and mid-variance blocks of the cover image utilizing a Walsh transform and the key.

19. A machine-readable medium having stored thereon instructions, which when executed by a machine, cause the machine to perform the following operations comprising:
partitioning a cover image;
generating a key;
inserting a watermark symbol into the cover image utilizing a Walsh transform and the key; and
extracting the watermark symbol from the cover image utilizing a Walsh transform and the key.

20. The machine-readable medium of claim 19, wherein generating the key includes generating a pseudo-random number.

21. The machine-readable medium of claim 20, wherein the key is a private key.

22. The machine-readable medium of claim 19, wherein the watermark symbol is a logo.

23. The machine-readable medium of claim 19, wherein partitioning a cover image includes partitioning the cover image into non-overlapping blocks of equal size.

24. The machine-readable medium of claim 23, further comprising:
defining blocks having small variance values as homogenous blocks; and
defining blocks having mid-variance values as mid-variance blocks.

25. The machine-readable medium of claim 24, further comprising:
spatially dispersing the watermark symbol utilizing the key; and
selecting homogenous blocks and mid-variance blocks.

26. The machine-readable medium of claim 25, wherein inserting the watermark symbol into the cover image utilizing a Walsh transform and the key includes inserting bits of the spatially dispersed watermark symbol into the homogenous and mid-variance blocks of the cover image utilizing a Walsh transform.

27. The machine-readable medium of claim 26, wherein extracting the watermark symbol from the cover image includes extracting bits of the spatially dispersed watermark symbol from the homogenous and mid-variance blocks of the cover image utilizing a Walsh transform and the key.

28. A system comprising:
a first image processor to perform operations including:
partitioning a cover image;
generating a key;
inserting a watermark symbol into the cover image utilizing a Walsh transform and the key; and
a second image processor to perform operations including extracting the watermark symbol from the cover image utilizing a Walsh transform and the key.

29. The system of claim 28, wherein generating the key includes generating a pseudo-random number utilizing a shift-register circuit.

30. The system of claim 29, wherein the key is a private key.

31. The system of claim 28, wherein the watermark symbol is a logo.

32. The system of claim 28, wherein partitioning a cover image includes partitioning the cover image into non-overlapping blocks of equal size.

33. The system of claim 32, wherein the first image processor further performs the operations of:
defining blocks having small variance values as homogenous blocks; and
defining blocks having mid-variance values as mid-variance blocks.

34. The system of claim 33, wherein the first image processor further performs the operations of:
spatially dispersing the watermark symbol utilizing the key; and
selecting homogenous blocks and mid-variance blocks.

35. The system of claim 34, wherein inserting the watermark symbol into the cover image utilizing a Walsh transform and the key includes inserting bits of the spatially dispersed watermark symbol into the homogenous and mid-variance blocks of the cover image utilizing a Walsh transform.

36. The system of claim 35, wherein extracting the watermark symbol from the cover image includes extracting bits of the spatially dispersed watermark symbol from the homogenous and mid-variance blocks of the cover image utilizing a Walsh transform and the key.
